(19) United States
(12) Patent Application Publication
(10) Pub. No.: US 2019/0134665 A1
(43) Pub. Date: May 9, 2019

(54) A METHOD FOR APPLYING A PRIMER, IN PARTICULAR A PRIMER FOR UV COATING SYSTEMS, ON THE SURFACE OF AN ELECTRICALLY CONDUCTIVE SUBSTRATE

(71) Applicant: SCHAEFFER AG, Berlin (DE)

(72) Inventor: Jens WEIDE, Berlin (DE)

(73) Assignee: SCHAEFFER AG, Berlin (DE)

(21) Appl. No.: 16/095,365

(22) PCT Filed: Apr. 21, 2017
(86) PCT No.: PCT/EP2017/059543

§ 371 Date: Oct. 21, 2018

(30) Foreign Application Priority Data
Apr. 22, 2016 (EP) 16166737.3

(51) Int. Cl. B05D 7/14; B05D 3/04; B05D 3/14; B05D 3/06

(52) U.S. Cl. CPC B05D 7/14; B05D 3/0493; B05D 2202/25; B05D 3/064; B05D 3/142

(57) ABSTRACT

The invention relates to a method for applying a primer, in particular a primer for UV coating systems, on an electrically conductive substrate, in particular a metal surface, comprising the steps of the treatment of the surface with process plasma providing an activated surface, and subsequently contacting of the plasma treated surface with a primer. The invention further relates to a pretreated surface comprising an electrically conductive substrate and a layer of a primer, which form an activated treatment surface for the treatment with a color characterized in that the activated surface is stable for at least several hours and a printed surface, in particular a printed surface comprising an electrically conductive substrate, a layer of a primer and a printed color layer, characterized in that the printed color layer is stable after immersion in water for more than 48 hours.

### FIELD OF THE INVENTION

The present invention relates to a method for applying a primer, in particular a primer for UV coating systems, on the surface of an electrically conductive substrate and compositions obtainable by this method.

### BACKGROUND OF THE INVENTION

The use of UV printing systems on the surface of a metal, in particular eloxadized (anodized) aluminium surfaces, is accompanied by a complex and expensive production process for achieving a product with a suitable binding strength of a primer on the metal surface and, thus, of the applied color via the primer on the metal surface.

Currently anodized aluminium surfaces that are processed with UV printing systems are pre-treated with a multi-step process, including a complex and expensive flame pyrolysis:
1. Pre-preparation
2. Cleaning
3. Flame pyrolysis
4. Primer application
5. Drying of the primer
6. Print
7. Cutting
8. Cleaning

There are only a few specialized providers.

One solution is for small hand-operated systems such as Flamprico (http://www.flamprico.de/)

The manual version is 100% handmade and time consuming. The burner is operated manually and the primer has to be sprayed with a spray gun. This results in an extremely high error rate, such as the use of low flame or primer provides a too low adhesion for a print. The application of too much flame or primer results in unsightly residue.

Since the primer contains acids and solvents a spray booth, protective masks and protective clothing are necessary for the process. Furthermore, it is critical that the handling of highly flammable primer and the flame pyrolysis are carried out in direct succession. Therefore, human error can result in dangerous accidents.

Another option are large systems offered by for example SurAChemicals (http://www.surachemicals.de/).

Such large plants comprise production roads—even smaller systems are very expensive and thus, not suited for the production of smaller batches. One reason is the necessary safety technology due to the handling of the primer and flame pyrolysis, which is only cost effective with larger batches.

After the flame treatment, a silane compound is applied onto the surface forming a crusty, tree-like structure. In other words, an extremely thin, very rough glass layer is applied to the surface. The following color comprises a good adhesion on this rough surface. However, the process is cost expensive, less accurate and hazardous.

Furthermore, the flame pyrolysis is particularly problematic for eloxadized plates. This applies to the manual version and to the automated lines. By using the flame pyrolysis parts of an eloxadized plate may be exposed to a larger amount of heat. This punctual heat “overdose” causes an expansion of the plate and rupturing of the anodized surface yielding a grid like pattern on the surface. Such plates are not suitable for sale. The UV printing of anodized aluminium is typically handled similarly to printing on glass. Many large providers of printing on aluminium dibond plates print on a thin film, which is attached directly to the aluminium plate in a second step. Thus, it is not printed on the aluminium itself.

Document WO 2013/017783 A1 describes a process for treating metal surfaces with atmospheric pressure plasma for the deposition of coatings without adhesion promoters (or primers according to the definition of the present application). The method described in WO 2013/017783 A1 aims at modifying a layer of organic material on the metal surface, such that colour can be directly applied to the surface without previous deposition of a primer on the surface.

However, primers are essential for the method according to the present invention in order to ensure sufficient adhesion of colour subsequently applied on the primer.

The objective of the present invention is to provide a method or a composition overcoming the above mentioned problems of the state of the art. This objective is attained by the subject-matter of the independent claims.

### TERMS AND DEFINITIONS

In the context of the present specification, the term primer refers to adhesion promoters. In other words, substances that produce a close physical or chemical bond in the interface of two immiscible substances, e.g. a surface and paint.

In the context of the present specification, the term surface of a substrate refers to any surface suitable for use in printing techniques such as plates or bicycle frames.

In the context of the present specification, the term pure refers to a purity of at least technical gate or higher.

In the context of the present specification, the term inert gas refers to a gaseous substance with such a low reactivity that there occurs no interaction with the surface to be treated with a plasma or the subsequently applied primer. Examples are noble gases or nitrogen.

In the context of the present specification, the term metal refers to chemical elements that are located in the periodic table of elements on the left side and below the dividing line from boron to astatine. The term is also used for alloys, metal compositions (such as metal oxide, particularly on the surface) and intermetallic phases. Thus, it applies to all materials which in solid form comprise the following four characteristic metallic material properties:
high electrical conductivity
high thermal conductivity,
ductility (deformability)
metallic gloss (mirror finish).

In the context of the present specification, the term oxidized metal surface refers to a metal oxide layer on the surface, particularly to an eloxadized (anodized) surface layer.

In the context of the present specification, the term process plasma refers to a particle mixture on atomic-molecular level, the components of which are partially charged components, thus, the plasma contains free charge carriers.

In the context of the present specification, the term alkene refers to straight or branched hydrocarbon chain moiety containing up to 8 carbon atoms and having at least one carbon-carbon double bond (alkenyl group). Examples of alkenyl groups include, without limitation, ethenyl, propenyl, butenyl, 1-methyl-2-buten-1-yl, dienes such as 1,3-butadiene and the like. Alkenyl groups as used herein may optionally include further substituent groups.

In the context of the present specification, the term alkine refers to a straight or branched hydrocarbon moiety containing up to 8 carbon atoms and having at least one carbon-carbon triple bond (alkynyl group). Examples of alkynyl groups include, without limitation, ethynyl, 1-propynyl, 1-butynyl, and the like. Alkynyl groups typically include from 2 to about 10 carbon atoms, more typically from 2 to about 4 carbon atoms. Alkynyl groups as used herein may optionally include further substituent groups.

In the context of the present specification, the term carboxylic acid refers to organic compounds, particularly comprising a straight or branched hydrocarbon moiety containing up to 8 carbon atoms, which carry one or more carboxyl group (—COOH), such as propanoic acid, ethanedioic acid, citric acid, benzoic acid or pyridine-3-carboxylic acid. In the context of the present specification, the term diamine refers to organic compounds, particularly comprising a straight or branched hydrocarbon moiety containing up to 8 carbon atoms, which carry two amine groups (—NH2), such as 1,2-diaminoethane, propane-1,3-diamine, butane-1,4-diamine, 1,2-diaminopropane or diphenylethylenediamine.

In the context of the present specification, the term diole refers to organic compounds, particularly comprising a straight or branched hydrocarbon moiety containing up to 8 carbon atoms, which carry two hydroxyl groups (—OH), such as ethylene glyco propane-1,2-diol or 1,3-propanediol.

In the context of the present specification, the term alkenylaryl refers to straight or branched hydrocarbon chain moiety containing up to 8 carbon atoms and having at least one carbon-carbon double bond (alkenyl group) and at least one aryl group. As used herein the term “aryl” refers to a hydrocarbon with alternating double and single bonds between the carbon atoms forming a ring structure (in the following an “aromatic hydrocarbon”). An example is styrene.

In the context of the present specification, the term polymer refers to a macromolecule having a molecular weight of at least 1000 Da, wherein the macromolecule is composed of a plurality of repeated subunits.

In the context of the present specification, the term monomer refers to a molecule having a molecular weight of less than 1000 Da. According to this definition, monomers may or may not be able to polymerize into polymers, wherein the monomers constitute the subunits of the polymer.

### SUMMARY OF THE INVENTION

The present invention was made in view of the prior art described above, and the problem underlying the present invention is to provide a method for applying a primer, in particular especially a primer for UV coating systems, on a surface of an electrically conductive substrate and compositions obtainable by this method. This problem is solved by the subject-matter of the independent claims.

According to a first aspect of the invention a method for applying a primer, in particular a primer for UV coating systems, on the surface of an electrically conductive substrate, in particular a metal substrate comprising the steps of
a. treatment of the surface with a process plasma providing an activated surface, and subsequently
b. contacting of the plasma treated surface with said primer is provided.

According to a second aspect of the invention a pretreated surface, in particular a pretreated surface obtainable by a method according to the first aspect of the invention, is provided, comprising an electrically conductive substrate, in particular a metal substrate, and layer of a primer, which form an activated treatment surface for the application of color, in particular UV color, characterized in that the activated surface is stable for at least several hours.

According to a third aspect of the invention a printed surface, in particular a printed surface obtainable by a method according to the first aspect of the invention, is provided, comprising an electrically conductive substrate, in particular a metal substrate, a layer of a primer and a printed color layer, in particular a printed UV color layer, characterized in that said printed color layer is stable after immersion in water for more than 48 hours.

### DETAILED DESCRIPTION OF THE INVENTION

According to a first aspect of the invention a method for applying a primer, in particular a primer for UV coating systems, on the surface of an electrically conductive substrate, in particular a metal substrate, comprising the steps of
a. treatment of the surface with a process plasma providing an activated surface, and subsequently
b. contacting of the plasma treated surface with said primer is provided.

The first step (the treatment of the surface with a process plasma) comprises a cleaning part (the surface is cleaned physically and chemically by an ion bombardment) and an activation part (formation of activated positions), providing an activated surface. The, thus, cleaned and activated surface allows for a high binding strength with the subsequently applied primer, in particular with the subsequently applied monomer yielding a monomer or polymer layer. Therein, in particular, a monomer layer is formed by the primer monomers. Depending on the chemical nature of the primers, the monomers may subsequently polymerize on the surface to form a polymer or polymer layer or remain in their monomeric state.

Before the contacting of the plasma treated surface with a primer, the plasma might be removed using reduced pressure or flooding with an inert gas. Alternatively, the primer might be applied directly after the activation process without removing the plasma enabling a simple and quick process. The primer may be applied on the surface in the gaseous phase, for example by providing the primer at reduced pressure, or in the liquid phase, for example at atmospheric pressure, depending on the volatility of the primer. When applied in the liquid phase, the primer may for example be sprayed or manually applied onto the activated (plasma treated) surface.

The pretreatment of the surface with the process plasma and the primer provides an activated surface, which can be stored for many days without losing a significant part of their adhesion ability towards color. Therefore, the activated surface can be pre-produced and treated with color after several days without any loss in the adhesion. This allows a highly flexibly process and a real time reaction to the current order situation. In certain embodiments, the treatment of the surface with the process plasma occurs under a process pressure lower than the atmospheric pressure.

In certain embodiments, the treatment of the surface with the process plasma occurs under a process pressure between 0.05 to 1 mbar.

In certain embodiments, the treatment of the surface with the process plasma occurs under a process pressure between 0.2 to 0.5 mbar, wherein particularly the process pressure is 0.3 mbar.

The use of a process pressure lower than the atmospheric pressure (low-pressure plasma) allows running the process with a low consumption of hydrogen. With atmospheric pressure plasma, the use of hydrogen would significantly increase and the safety measures due to the risk of explosion and fire will also increase.

In certain embodiments, the duration of the treatment of the surface with a process plasma is at least one minutes, in particular at least one five minutes.

The duration is referenced to the use of a hydrogen-argon gas bottle (“Arcal Plasma 62”) with an inner diameter of hydrogen-argon gas tube of 3.5 mm and wherein the pressure reducer on the gas cylinder is set to one bar and wherein the process pressure is 0.3 mbar and the initiation pressure is 0.5 mbar.

In certain embodiments, the surface of an electrically conductive substrate comprises, in particular is, an oxidized metal surface, in particular an oxidized aluminum surface.

In certain embodiments, the process plasma comprises hydrogen gas.

Particularly the use of hydrogen gas in the process plasma yields good results, in particular in combination with oxidized metal surfaces, more particularly with oxidized aluminum surfaces.

In certain embodiments, the process plasma comprises pure hydrogen gas or a mixture of hydrogen gas and at least one inert gas.

In certain embodiments, the process plasma comprises a mixture of hydrogen gas and at least one inert gas.

In certain embodiments, the process plasma comprises hydrogen gas in the range of 5% to 60% and at least one inert gas in the range of 95% to 40%.

In certain embodiments, the process plasma comprises hydrogen gas in the range of 10% to 40% and at least one inert gas in the range of 90% to 60%.

In certain embodiments, the process plasma comprises hydrogen gas in in the range of 15% to 25% and at least one inert gas in the range of 85% to 75%.

In certain embodiments, the process plasma used is “Arcal Plasma 62” (20% H₂ content) of Air Liquide Deutschland GmbH.

All the above mentioned ratios are measured in percent per volume.

In general, the activation of the surface area is achieved by the hydrogen of the plasma. Thus, the use of pure hydrogen gas in the plasma is possible but not necessary to achieve good results. The use of a lesser amount of hydrogen is more cost effective. Furthermore, due to a larger amount of inert gases workplace hazard such as explosions or fire are reduced and less safeties measures are necessary reducing the cost of the process even further.

The addition of O₂ to the process plasma in the process step (cleaning/activation) comprises a reduced adhesion. The identical process with ambient air causes about a 30% separation of the printing ink after milling.

The method of the invention allows the use of surface material (e.g. aluminum plates) without cleaning step before the process, since the process plasma of the first step accomplishes this purpose. Thus, less time is required and the handling of the surface material (e.g. aluminum plates) is easier.

A simple mechanical cleaning might be necessary due to dust settled on the surface. The surface can be swept with a commercially available hand brush without damaging the layer, particularly the monomer or polymer layer, of the invention, which endures such a mechanical contact.

In certain embodiments, the at least one inert gas is selected from the group comprising nitrogen, helium, neon, argon, krypton or xenon, or a mixture thereof.

In certain embodiments, the at least one inert gas is selected from the group comprising nitrogen and argon or a mixture thereof.

In certain embodiments, the at least one inert gas is argon.

In certain embodiments, the process plasma comprises a mixture of hydrogen gas and at least one inert gas, wherein in particular the inert gas is argon and the surface is an oxidized metal surface, in particular an oxidized aluminum surface.

In certain embodiments, the process plasma comprises hydrogen gas in the range of 15% to 25% and at least one inert gas in the range of 85% to 75%, wherein in particular the inert gas is argon and the surface of an electrically conductive substrate is an oxidized metal surface, in particular an oxidized aluminum surface.

In certain embodiments, the gas for the process plasma used is “Arcal Plasma 62” of Air Liquide Deutschland GmbH and the surface of an electrically conductive substrate is an oxidized metal surface, in particular an oxidized aluminum surface.

In certain embodiments, the primer is a monomer, in particular a volatile monomer, providing a monomer or polymer layer, wherein more particularly the monomer is a monomer suitable for graft-copolymerization. In other words, such a monomer primer may form a layer on the activated surface while remaining in its monomeric state or the monomer primer may polymerize during or after application onto the activated surface, thus forming a polymer layer on the activated surface. The use of a gaseous monomer (derived from a liquid or gaseous monomer) allows for an even application of the primer with a very low amount of necessary primer.

In certain embodiments, the primer is suitable for graft-copolymerization. For example, acrylic acid (prop-2-enoic acid) is commonly used for graft-copolymerization. However, these primers may or may not form a graft-copolymer on the activated surface in the method according to the present invention. For example, such primers may form a monomer layer or a polymer layer which is not a graft copolymer (such as linear polymer chains).

In certain embodiments, the primer is volatile. Therein, the term ‘volatile’ designates an organic substance, in other words a substance primarily consisting of hydrogen and carbon atoms, having an initial boiling point of 250° C. or less at a standard pressure of 101.3 kPa. The initial boiling point is defined as the temperature value at which the first bubble of vapor is formed from the liquid substance.

In particular such primers are in the gaseous state at the operating pressure of the plasma device used during plasma activation of the surface (0.05 mbar to 1 mbar).

In certain embodiments, the primer is at least partially in the gaseous state at a pressure of 1 mbar or less.

For example, such volatile primers may be provided in a container which is open to the interior of a plasma device used to activate the surface at reduced pressure, wherein the primer evaporates at the reduced pressure, and contacts the surface in its gaseous state, forming a layer on the surface.

Furthermore, non-volatile primers which are in the liquid state at atmospheric pressure and at ambient temperature may be used. Such primers may for example be sprayed or manually applied to the activated (plasma treated) surface.

In certain embodiments, the primer is selected from the group of a C₁-C₈ alkene, C₁-C₈ alkine, C₁-C₈ carboxylic acid, C₁-C₈ diamine, a C₁-C₈ diole, R₁—CN, R₁—COOH or R₁—COOR₂, with R₁ being a C₁-C₈ alkene, C₁-C₈ alkenylaryl or C₁-C₈ alkine, in particular a C₁-C₈ alkene, and R₂ being a C₁-C₈ alkyl, in particular a C₁ alkyl.

In certain embodiments, the primer is selected from the group of a C₁-C₄ alkene, C₁-C₄ alkine, C₁-C₄ carboxylic acid, C₁-C₄ diamine, a C₁-C₄ diole, R₁—CN, R₁—COOH or R₁—COOR₂, with R₁ being a C₁-C₄ alkene, C₁-C₄ alkenylaryl or C₁-C₄ alkine, in particular a C₁-C₄ alkene, and R₂ being a C₁-C₄ alkyl, in particular a C₁ alkyl.

In certain embodiments, the primer is selected from R₁—COOH, with R₁ being a C₁-C₄ alkene, C₁-C₄ alkenylaryl or C₁-C₄ alkine, in particular a C₁-C₄ alkene.

In certain embodiments, the primer is selected from the group of a C₁-C₈ alkene, R₁—CN, R₁—COOH or R₁—COOR₂, with R₁ being a C₁-C₈ alkene, C₁-C₈ alkenylaryl or C₁-C₈ alkine, in particular a C₁-C₈ alkene, and R₂ being a C₁-C₈ alkyl, in particular a C₁ alkyl.

In certain embodiments, the primer is selected from the group of a C₁-C₄ alkene, R₁—CN, R₁—COOH or R₁—COOH₂, with R₁ being a C₁-C₄ alkene, C₁-C₄ alkenylaryl or C₁-C₄ alkine, in particular a C₁-C₄ alkene, and R₂ being a C₁-C₄ alkyl, in particular a C₁ alkyl.

In certain embodiments, the primer is selected from R₁—COOH, with R₁ being a C₁-C₄ alkene, C₁-C₄ alkenylaryl or C₁-C₄ alkine, in particular a C₁-C₄ alkene.

In certain embodiments, the primer is selected from the group of acrylonitrile, butadiene, styrene, methyl 2-methylpropenoate, prop-2-enoic acid, methyl-propenoate, ethyl-propenoate, butyl prop-2-enoate, 2-hydroxyethyl 2-methylprop-2-enoate, in particular from prop-2-enoic acid.

In certain embodiments, the primer is selected from the group of a C₁-C₈ alkene, C₁-C₈ alkine, C₁-C₈ carboxylic acid, C₁-C₈ diamine, a C₁-C₈ diole, R₁—CN, R₁—COOH, R₁—COOR₂, or R₁—COO-L-Si—(OR₃)₃ with R₁ being a C₁-C₈ alkene, C₁-C₈ alkenylaryl or C₁-C₈ alkine, in particular a C₁-C₈ alkene, R₂ being a C₁-C₈ alkyl, in particular a C₁ alkyl, R₃ being a C₁-C₄ alkyl, in particular a C₁ alkyl, and L being a C₁-C₆ alkyl, in particular a C₁-C₄ alkyl.

In certain embodiments, the primer is selected from the group of a C₁-C₄ alkene, C₁-C₄ alkine, C₁-C₄ carboxylic acid, C₁-C₄ diamine, a C₁-C₄ diole, R₁—CN, R₁—COOH, R₁—COOR₂, or R₁—COO-L-Si—(OR₃)₃ with R₁ being a C₁-C₄ alkene, C₁-C₄ alkenylaryl or C₁-C₄ alkine, in particular a C₁-C₄ alkene, R₂ being a C₁-C₄ alkyl, in particular a C₁ alkyl, R₃ being a C₁-C₄ alkyl, in particular a C₁ alkyl, and L being a C₁-C₆ alkyl, in particular a C₁-C₄ alkyl.

In certain embodiments, the primer is selected from R₁—COOH or R₁—COO-L-Si—(OR₃)₃, with R₁ being a C₁-C₄ alkene, C₁-C₄ alkenylaryl or C₁-C₄ alkine, in particular a C₁-C₄ alkene, R₃ being a C₁-C₄ alkyl, in particular a C₁ alkyl, and L being a C₁-C₆ alkyl, in particular a C₁-C₄ alkyl.

In certain embodiments, the primer is selected from the group of a C₁-C₈ alkene, R₁—CN, R₁—COOH, R₁—COOR₂, or R₁—COO-L-Si—(OR₃)₃ with R₁ being a C₁-C₈ alkene, C₁-C₈ alkenylaryl or C₁-C₈ alkine, in particular a C₁-C₈ alkene, R₂ being a C₁-C₈ alkyl, in particular a C₁ alkyl, R₃ being a C₁-C₄ alkyl, in particular a C₁ alkyl, and L being a C₁-C₆ alkyl, in particular a C₁-C₄ alkyl.

In certain embodiments, the primer is selected from the group of a C₁-C₄ alkene, R₁—CN, R₁—COOH, R₁—COOR₂, or R₁—COO-L-Si—(OR₃)₃ with R₁ being a C₁-C₄ alkene, C₁-C₄ alkenylaryl or C₁-C₄ alkine, in particular a C₁-C₄ alkene, R₂ being a C₁-C₄ alkyl, in particular a C₁ alkyl, R₃ being a C₁-C₄ alkyl, in particular a C₁ alkyl, and L being a C₁-C₆ alkyl, in particular a C₁-C₄ alkyl.

In certain embodiments, the primer is selected from R₁—COOH or R₁—COO-L-Si—(OR₃)₃, with R₁ being a C₁-C₄ alkene, C₁-C₄ alkenylaryl or C₁-C₄ alkine, in particular a C₁-C₄ alkene, R₃ being a C₁-C₄ alkyl, in particular a C₁ alkyl, and L being a C₁-C₆ alkyl, in particular a C₁-C₄ alkyl.

In certain embodiments, the primer is selected from the group of acrylonitrile, butadiene, styrene, methyl 2-methylpropenoate, prop-2-enoic acid, methyl-propenoate, ethyl-propenoate, butyl prop-2-enoate, 2-hydroxyethyl 2-methylprop-2-enoate, or 3-trimethoxysilylpropylmethacrylate, in particular from prop-2-enoic acid or 3-trimethoxysilylpropylmethacrylate.

In certain embodiments, the primer is prop-2-enoic acid. In particular, the prop-2-enoic acid primer is applied on the activated surface in the gaseous phase at reduced pressure. Due to its volatility, this primer can be provided in the gaseous phase at reduced pressure. In particular, the contacting of the activated surface with the prop-2-enoic acid primer is performed in a plasma device, in which the plasma treatment of the surface is performed.

In certain embodiments, the primer is 3-trimethoxysilylpropylmethacrylate. In particular the 3-trimethoxysilylpropylmethacrylate primer is sprayed or manually applied on the activated surface at atmospheric pressure.

In certain embodiments, the primer is R₁—COO-L-Si—(OR₃)₃, with R₁ being a C₁-C₈ alkene, C₁-C₈ alkenylaryl or C₁-C₈ alkine, in particular a C₁-C₈ alkene, R₃ being a C₁-C₄ alkyl, in particular a C₁ alkyl, and L being a C₁-C₆ alkyl, in particular a C₁-C₄ alkyl.

In certain embodiments, the primer is R₁—COO-L-Si—(OR₃)₃, with R₁ being a C₁-C₄ alkene, C₁-C₄ alkenylaryl or C₁-C₄ alkine, in particular a C₁-C₄ alkene, R₃ being a C₁-C₄ alkyl, in particular a C₁ alkyl, and L being a C₁-C₆ alkyl, in particular a C₁-C₄ alkyl.

In certain embodiments, the primer is mixed with a carboxylic acid, particularly acetic acid or an alcohol, particularly isopropyl alcohol, prior to or during contacting the plasma treated surface with the primer, in particular prior to contacting the plasma treated surface with the primer.

In certain embodiments, the primer is mixed with a carboxylic acid, particularly acetic acid and an alcohol, particularly isopropyl alcohol, prior to or during contacting the plasma treated surface with the primer, in particular prior to contacting the plasma treated surface with the primer. A carboxylic acid in combination with an alcohol advantageously improves the formation of a primer layer on the surface, in particular when 3-trimethoxysilylpropylmethacrylate is used as a primer.

In particular, the plasma treated surface is contacted with the primer or the mixture of the primer and additives, such as the carboxylic acid and the alcohol, by spraying or manual application (i.e. by means of a cloth, such as a non-woven cloth). The application of the primer may be performed while the surface is still positioned in a plasma device used for plasma treatment of the surface. Alternatively, the primer can be applied to the surface after the surface is removed from the plasma device.

In certain embodiments, the treatment of the surface with a process plasma occurs under atmospheric pressure or higher.

In certain embodiments, the treatment of the surface with a process plasma occurs under a process pressure lower than the atmospheric pressure.

In certain embodiments, the treatment of the surface with a process plasma occurs under a process pressure between 0.2 to 0.5 mbar.

In certain embodiments, the treatment of the surface with a process plasma occurs under a process pressure of 0.3 mbar.

In certain embodiments, the duration of treatment of the surface with a process plasma is in the range of 5 min to 30 min. After 30 minutes there was no recognizable improvement of the treated surface.

In certain embodiments, the contacting of the plasma treated surface occurs under a process pressure lower than the atmospheric pressure.

In certain embodiments, the contacting of the plasma treated surface occurs under a process pressure between 0.1 mbar to 0.3 bar.

In certain embodiments, the contacting of the plasma treated surface occurs under a process pressure of 0.2 bar.

In certain embodiments, the contacting of the plasma treated surface with the primer occurs under a process pressure between 0.05 to 1 mbar.

The application of a gaseous monomer is important and can be achieved by different ways. A monomer can be used which is gaseous under room temperature and atmospheric pressure. Or a liquid, in particular volatile, monomer (such as acrylic acid) can be used, which is brought into the gaseous phase by the application of a pressure below atmospheric pressure. Additionally or alternatively the monomer can be heated.

In certain embodiments, the duration of the contacting of the plasma treated surface is at least five minutes.

In certain embodiments, the duration of the contacting of the plasma treated surface is in the range of 5 min to 30 min. After 30 minutes there was no recognizable improvement of the treated surface.

The duration is referenced to the use of acrylic acid (CAS No.: 79-10-7) applied under reduced process pressure (0.2 bar), wherein the initiation pressure is 0.1 mbar, via a gas tube with an inner diameter of 3.5 mm.

In certain embodiments, after the contacting of the plasma treated surface with the primer, a color is applied to the primer.

In certain embodiments, after the contacting of the plasma treated surface with the primer, a color is applied on the primer.

In certain embodiments, after the contacting of the plasma treated surface with the primer, a UV color is applied to the primer.

In certain embodiments, after the contacting of the plasma treated surface with the primer, a UV color is applied on the primer.

In certain embodiments, after the contacting of the plasma treated surface with the primer, a color is applied to the monomer or polymer layer.

In certain embodiments, after the contacting of the plasma treated surface with the primer, a color is applied on the monomer or polymer layer.

In certain embodiments, after the contacting of the plasma treated surface with the primer, a UV color is applied to the monomer or polymer layer.

In certain embodiments, after the contacting of the plasma treated surface with the primer, a UV color is applied on the monomer or polymer layer.

In certain embodiments, the application of color is achieved by a printer.

It is difficult to apply a durable coating on metal (or alloy) surfaces, in particular anodized aluminium surfaces. Particularly anodized aluminium surfaces comprise, aside from hardness and scratch resistance, a poor adhesion of dirt and color, which is one of the reasons why anodized aluminium plates are used in architecture. The anodized surface is basically “chemically inert” and does not or very poorly react with other chemicals. Additionally, all ultraviolet (UV) printing systems comprise a rather poor inherent adhesion because UV inks are applied on a surface and cured instantly by light. UV inks do not—compared to conventional ink-jet printing on paper—move into the material.

Combining UV printing on anodized material is therefore very demanding and difficult. Additionally, the aluminium plates may be further processed with harsh condition resulting in a high requirement profile on the primer. Aluminium plates might be processed after printing with milling tools and “bathed” in ethanol (see examples).

Aside from the good adhesion properties and the uniform application, the primer—applied according to the method of the invention—comprises a further feature. The thus applied primer cannot be seen or felt. In particular when for example aluminium plates are fully printed or if small logos or letters are printed it is important the primer is invisible and cannot be felt. To the best of the knowledge of the inventors there is no chemical primer that meets these requirements at the moment.

According to a second aspect of the invention a pretreated surface, in particular a pretreated surface obtainable by a method according to the first aspect of the invention, comprising an electrically conductive substrate, in particular a metal substrate, and a layer of a primer, which form an activated treatment surface for the treatment with a color, in particular an UV color, characterized in that the activated surface is stable for at least several hours, is provided.

In certain embodiments, the surface of said electrically conductive substrate is an oxidized metal surface, in particular an oxidized aluminum surface.

In certain embodiments, the pretreated surface is stable for at least several days.

In certain embodiments, the pretreated surface is stable for at least 7 days.

In certain embodiments, the pretreated surface is stable for at least 14 days.

In certain embodiments, the pretreated surface is stable for at least 21 days.

A stable pretreated surface can be printed with color, in particular UV color, without any loss of adhesion of the color on the surface, e.g. after milling.

Reference is made to the detailed description of the first aspect of the invention for further features or explanations.

According to a third aspect of the invention a printed surface, in particular a printed surface obtainable by a method according to any one of the claims 1 to 13, is provided, comprising a surface of an electrically conductive substrate, in particular a metal substrate, a layer of a primer and a printed color layer, in particular a printed UV color layer, characterized in that the printed color layer is stable after immersion in water for more than 48 hours.

In certain embodiments, the printed color layer is stable after contacting the printed color layer with organic solvents such as ethanol. In certain embodiments, the printed color layer is stable after mechanical stress such as CNC milling.

A stable printed color layer remains after the above mentioned treatment on the surface and does not peel off.

Reference is made to the detailed description of the first aspect of the invention for further features or explanations.

### SHORT DESCRIPTION OF THE FIGURES

FIG. 1 shows an eloxadized aluminium plate obtained according to the invention using a plasma comprising hydrogen gas (“Arcal Plasma 62”) with an excellent adhesion of the color on the plate after milling;

FIG. 2 shows an eloxadized aluminium plate obtained according to the Flamprico flame pyrolysis process with a poor adhesion of the color on the plate after milling;

FIG. 3 shows an eloxadized aluminium plate obtained according to the invention using plasma comprising 30% oxygen with a poor adhesion of the color on the plate after milling;

FIG. 4 shows an eloxadized aluminium plate obtained according to the invention using a plasma comprising hydrogen gas (“Arcal Plasma 62”) with an excellent adhesion of the color on the plate after immersion in water for two weeks;

FIG. 5 shows an eloxadized aluminium plate obtained according to the Flamprico flame pyrolysis process with a poor adhesion of the color on the after immersion in water for two days;

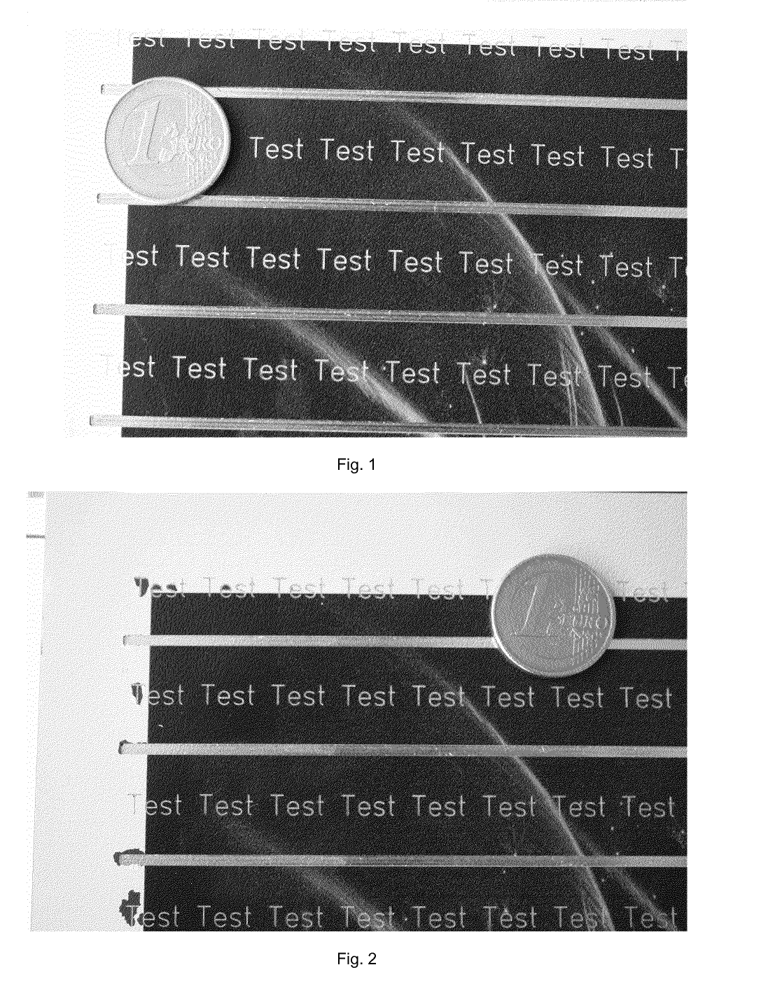

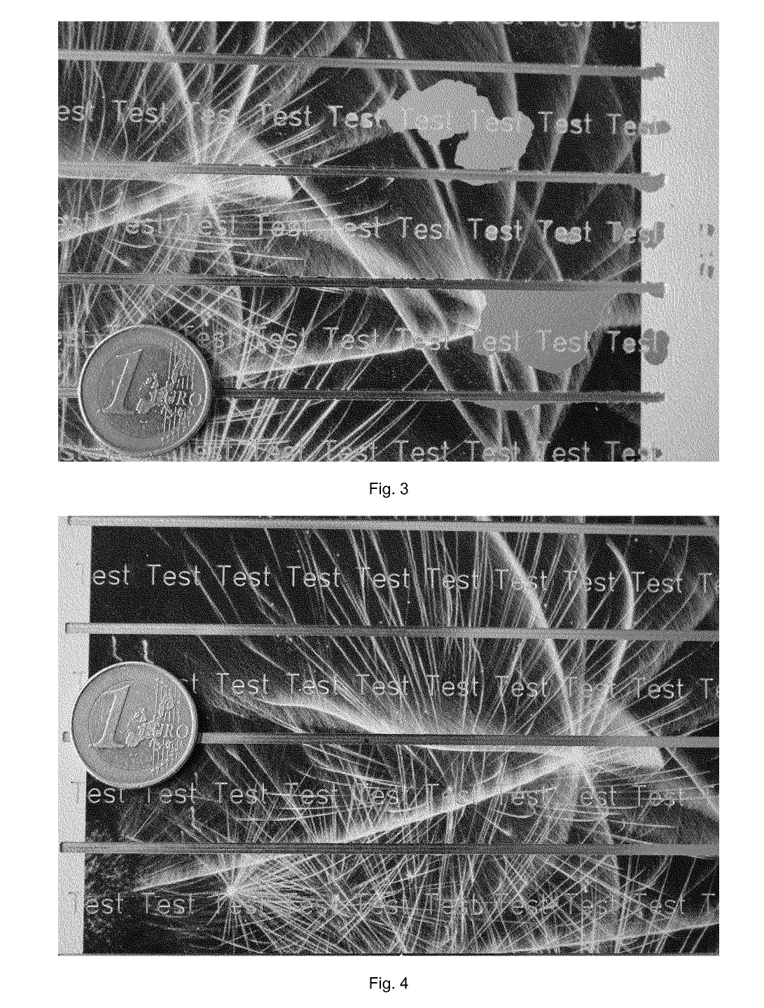

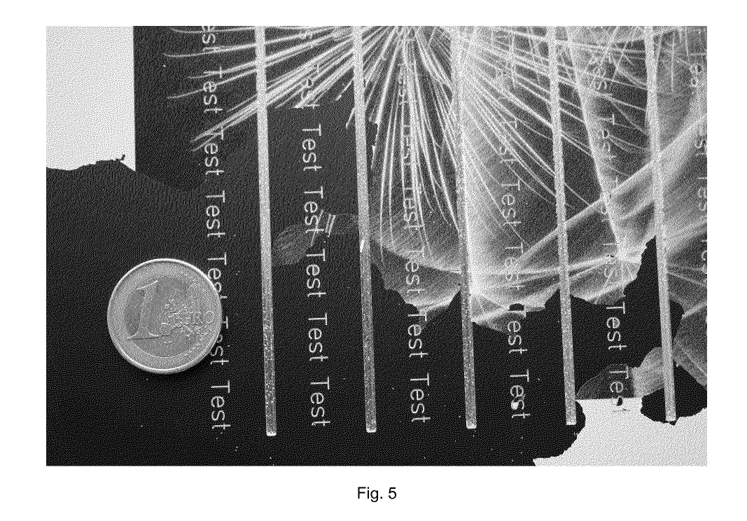

In the figures, an aluminium plate can be seen, which was first pre-treated according to the invention or with the flame pyrolysis and then printed. After printing, it was machined on a CNC machining centre, with the application of a large amount of coolant (here ethanol). The words “test test test . . . ” and the horizontal “bars” were engraved and were not provided by the application of the printed color layer. Milled (engraved) elements comprise especially at the edges extreme demands on the adhesion.

### EXAMPLES

### Method of the Invention

A plasma system PAC357Spot 2.5KW of the company plasma technology GmbH (Herrenberg/Gultstein Germany) was used.

First Step (Pre-Preparation Step):

The protective film of anodized aluminium plate was removed and the anodized aluminium plate was put into the plasma system without further cleaning—thus there is no time delay for the drying of the cleaner.

Second Step (H₂ Plasma Process):

The surface is cleaned and activated by the low pressure plasma comprising H₂ and other gases. The process conditions can be found below:

Initiation pressure: 0.5 mbar

Process pressure: 0.3 mbar

Process time: 5 minutes or longer

Gas: hydrogen argon mixture “Arcal Plasma 62” of Air Liquide Deutschland GmbH

Third Step (Polymerization/Layer Formation):

A primer is applied to the surface in form a monomer or polymer layer under low pressure.

The process conditions can be found below:

Initiation pressure: 0.1 mbar

Process pressure: 0.2 bar

Acrylic acid polymerization/layer formation process

Process time: 5 minutes or longer

Acrylic acid used: acrylic acid (stabilized with hydroquinone monomethyl ether) for synthesis (CAS No.: 79-10-7)

Fourth Step (Printing):

The plate is removed from the plasma system and subsequently printed with IJC255 ink by a Canon Océ Arizona UV printer system.

If necessary, the plate is swept with a commercially available hand brush—the monomer or polymer layer of the invention endures these mechanical contacts.

Fifth Step (Cutting):

If necessary, the anodized aluminium plate is cut to the appropriate form with high feed rates and speeds. As a coolant ethanol is used.

Sixth Step (Cleaning):

If necessary, the anodized aluminium plate is cleaned with n-butyl acetate-based detergents.

Manual Flame Pyrolysis “Flamprico”:

The protective film is peeled off from the aluminium plate and the aluminium plate is then cleaned. A specific, “scratch free” microfiber cloth (“non-woven”), which can only be used once, and the “Flamprico Cleaner”, a highly flammable liquid which causes severe eye irritation and may cause drowsiness and dizziness, have to be used. Solvent resistant protective gloves and a tight-fitting safety goggles must be worn and sufficient ventilation has to be provided.

The flame treatment step is applied after drying of the cleaner. It is of utmost importance that the cleaner has dried to 100%, otherwise it might catch fire with the flame pyrolysis.

Furthermore, precautions have to be taken if the provided flame pyrolysis “Flamprico gas” comprising silane is used. Since the gas is an extremely flammable gas, in particular an electrostatic charge in the environment must be prevented, which is quite laborious. The flaming must be done manually in such a way that the same amount of silane is applied per unit area. Not enough silane reduces the adhesion, excess silane produces white, veil-like impurities in the aluminium, which cannot be removed with conventional cleaning agents and sponges. When these impurities occur, the process has to be repeated with a new aluminium plate. After the flame treatment is finished, “Flamprico 2030 primer” must be applied in a timely manner. The primer is applied by a spray gun under safety measures (gloves, goggles and a protective mask with solvent filter). It is carried out under sufficient ventilation. Since liquid and vapour are highly flammable, it is important that the aluminium surface is cooled before the primer is applied. For the process, it is important that the surface is still hot when applying the primer. If too much primer is applied, the plates have to dry for up to 24 hours before they can be processed further otherwise the adhesion is very poor. If too little primer is used the adhesion is also poor. This process is also determined by the manual application of the primer.

After the two-step process is finished, the UV ink adheres very well to the surface of the anodized material. As a test method, special test panels were milled after printing on CNC machining centres. The extreme stress by the rotating cutters and the use of coolant (ethanol) are a burden on the coating. Test panels produced with a flame pyrolysis process showed that 25% to 33% of the printing plates comprised after the milling unsightly discoloration or the print is chipped. All of the test panels produced according to the method of the invention showed no discoloration or chipping after the milling.

Furthermore, the print is resistant to the interaction with ethanol (bath, one hour) and against wiping with n-butyl acetate of.

The print will separate if test panels produced with the flame pyrolysis method are placed into cold tap water for 24 to 48 hours. Test panels produced according to the method of the invention showed no separation—even after 504 hours water. This is particularly important for use on outdoor signs.

Furthermore, the plasma pretreatment time can be 16-18 days, without losing a significant part of adhesion, when the primer is applied by this time. Thereafter, the print is no longer optimal (about 10% loose color after milling).

Additionally, the method of the invention comprises only very few steps and consumes a very low amount of material, which significantly reduces the production time and cost.

For example a 50 litre and 200 bar gas bottle (Arcal plasma 62) and one litre of acrylic acid allows for two months continuous printing. The material cost per-treatment is therefore extremely low.

1. A method for applying a primer, in particular a primer for UV coating systems, on the surface of an anodized aluminium surface, comprising the steps of
a. treatment of the surface with a process plasma providing an activated surface, wherein the treatment of the surface with said process plasma occurs under a process pressure lower than the atmospheric pressure, and subsequently
b. contacting of the plasma treated surface with said primer.

2. The method according to claim 1, wherein the treatment of the surface with said process plasma occurs under a process pressure between 0.05 to 1 mbar.

3. The method according to claim 1, wherein the treatment of the surface with said process plasma occurs under a process pressure between 0.2 to 0.5 mbar, wherein particularly the process pressure is 0.3 mbar.

4. (canceled)

5. The method according to claim 1, wherein the process plasma comprises hydrogen gas, in particular pure hydrogen gas or a mixture of hydrogen gas and at least one inert gas, more particularly a mixture of hydrogen gas and at least one inert gas.

6. The method according to claim 5, wherein the process plasma comprises hydrogen gas in the range of 5% to 60% and at least one inert gas in the range of 95% to 40%, in particular hydrogen gas in the range of 10% to 40% and at least one inert gas in the range of 90% to 60%, more particularly hydrogen gas in the range of 15% to 25% and at least one inert gas in the range of 85% to 75%.

7. The method according to claim 5, wherein the at least one inert gas is selected from the group comprising nitrogen, helium, neon, argon, krypton, xenon or a mixture thereof, in particular from nitrogen and argon or a mixture thereof, more particularly the at least one inert gas is argon.

8. The method according to claim 1, wherein the primer is a monomer, in particular a volatile monomer, providing a monomer or polymer layer, wherein more particularly the monomer is a monomer suitable for graft-copolymerization.

9. The method according claim 8, wherein the primer is selected from the group of a C₁-C₈ alkene, C₁-C₈ alkine, C₁-C₈ carboxylic acid, C₁-C₈ diamine, a C₁-C₈ diole, R₁—CN, R₁—COOH, R₁—COOR₂, or R₁—COO-L-Si—(OR₃)₃, with R₁ being a C₁-C₈ alkene, C₁-C₈ alkenylaryl or C₁-C₈ alkine, in particular a C₁-C₈ alkene, R₂ being a C₁-C₈ alkyl, in particular a C₁ alkyl, R₃ being a C₁-C₄ alkyl, in particular a C₁ alkyl, and L being a C₁-C₆ alkyl, in particular a C₁-C₄ alkyl, wherein in particular the primer is selected from the group of a C₁-C₄ alkene, C₁-C₄ alkine, C₁-C₄ carboxylic acid, C₁-C₄ diamine, a C₁-C₄ diole, R₁—CN, R₁—COOH, R₁—COOR₂, or R₁—COO-L-Si—(OR₃)₃, with R₁ being a C₁-C₄ alkene, C₁-C₄ alkenylaryl or C₁-C₄ alkine, in particular a C₁-C₄ alkene, R₂ being a C₁-C₄ alkyl, in particular a C₁ alkyl, R₃ being a C₁-C₄ alkyl, in particular a C₁ alkyl, and L being a C₁-C₆ alkyl, in particular a C₁-C₄ alkyl, wherein more particularly the primer is selected from R₁—COOH or R₁—COO-L-Si—(OR₃)₃, with Ri being a C₁-C₄ alkene, C₁-C₄ alkenylaryl or C₁-C₄ alkine, in particular a C₁-C₄ alkene, R₃ being a C₁-C₄ alkyl, in particular a C₁ alkyl, and L being a C₁-C₆ alkyl, in particular a C₁-C₄ alkyl.

10. The method according to claim 8any one of the previous claims, wherein the primer is selected from the group of a C₁-C₈ alkene, R₁—CN, R₁—COOH, R₁—COOR₂, or R₁—COO—L—Si—(OR₃)₃, with R₁ being a C₁-C₈ alkene, C₁-C₈ alkenylaryl or C₁-C₈ alkine, in particular a C₁-C₈ alkene, R₂ being a C₁-C₈ alkyl, in particular a C₁ alkyl, R₃ being a C₁-C₄ alkyl, in particular a C₁ alkyl, and L being a C₁-C₆ alkyl, in particular a C₁-C₄ alkyl, wherein in particular the primer is selected from the group of a C₁-C₄ alkene, R₁—CN, R₁—COOH, R₁—COOR₂, or R₁—COO-L-Si—(OR₃)₃ with R₁ being a C₁-C₄ alkene, C₁-C₄ alkenylaryl or C₁-C₄ alkine, in particular a C₁-C₄ alkene, R₂ being a C₁-C₄ alkyl, in particular a C₁ alkyl, R₃ being a C₁-C₄ alkyl, in particular a C₁ alkyl, and L being a C₁-C₆ alkyl, in particular a C₁-C₄ alkyl, wherein more particularly the primer is selected from R₁—COOH or R₁—COO-L-Si—(OR₃)₃, with R₁ being a C₁-C₄ alkene, C₁-C₄ alkenylaryl or C₁-C₄ alkine, in particular a C₁-C₄ alkene, R₃ being a C₁-C₄ alkyl, in particular a C₁ alkyl, and L being a C₁-C₆ alkyl, in particular a C₁-C₄ alkyl.

11. The method according to claim 8, wherein the primer is selected from the group of acrylonitrile, butadiene, styrene, methyl 2-methylpropenoate, prop-2-enoic acid, methyl-propenoate, ethyl-propenoate, butyl prop-2-enoate, 2-hydroxyethyl 2-methylprop-2-enoate, or 3-trimethoxysilylpropylmethacrylate, in particular from prop-2-enoic acid or 3-trimethoxysilylpropylmethacrylate, more particularly from 3-trimethoxysilylpropylmethacrylate.

12. The method according to claim 8, wherein the primer is R₁—COO-L-Si—(OR₃)₃, with R₁ being a C₁-C₄ alkene, C₁-C₄ alkenylaryl or C₁-C₄ alkine, in particular a C₁-C₄ alkene, R₃ being a C₁-C₄ alkyl, in particular a C₁ alkyl, and L being a C₁-C₆ alkyl, in particular a C₁-C₄ alkyl.

13. The method according to claim 12, wherein said primer is mixed with a carboxylic acid, particularly acetic acid and/or an alcohol, particularly isopropyl alcohol, prior to or during contacting said plasma treated surface with said primer, in particular prior to contacting said plasma treated surface with said primer.

14. The method according to claim 1, wherein the contacting of the plasma treated surface with the primer occurs under a process pressure lower than the atmospheric pressure, in particular between 0.1 mbar to 0.3 bar, more particularly the process pressure is around 0.2 bar, in particular wherein the primer is a volatile monomer.

15. The method according to claim 14, wherein the contacting of the plasma treated surface with the primer occurs under a process pressure between 0.05 to 1 mbar.

16. The method according to claim 1, wherein after the contacting of the plasma treated surface with the primer, a color, in particular an UV color, is applied on the primer, in particular on the monomer or polymer layer.

17. The method according to claim 16, wherein the application of the color is achieved by a printing method.

18. A pretreated surface, in particular a pretreated surface obtainable by a method according to claim 1, comprising an anodized aluminium substrate, and a layer of a primer, which form an activated treatment surface for the application of color, in particular UV color, characterized in that the activated surface is stable for at least several hours.

19. A printed surface, in particular a printed surface obtainable by a method according to claim 1, comprising an anodized aluminium surface, a layer of a primer and a printed color layer, in particular a printed UV color layer, characterized in that the printed color layer is stable after immersion in water for more than 48 hours.

20. The method according to claim 6, wherein the at least one inert gas is selected from the group comprising nitrogen, helium, neon, argon, krypton, xenon or a mixture thereof, in particular from nitrogen and argon or a mixture thereof, more particularly the at least one inert gas is argon.
